(19) United States
(12) Patent Application Publication
(10) Pub. No.: US 2010/0280965 A1
(43) Pub. Date: Nov. 4, 2010

(54) METHOD AND APPARATUS FOR INTUITIVE MANAGEMENT OF PRIVACY SETTINGS

(75) Inventors: Matti Vesterinen, Espoo (FI); Matti Johannes Nelimarkka, Helsinki (FI); Teemu Harju, Masala (FI); Tomi Kulmala, Helsinki (FI); Ville Rantala, Mikkeli (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/433,714

(22) Filed: Apr. 30, 2009

(51) Int. Cl. G06Q 99/00

(52) U.S. Cl. 705/319; 715/853; 709/204

(57) ABSTRACT

An approach is provided for intuitive management of privacy settings, which includes receiving data that indicates a contact radius and an information radius. The contact radius is related to how socially close a contact is to a user who is registered with a network service. The information radius is related to how private the information about the user is. In response to a request from the contact for information about the user, information about the user is provided, which has an information radius value in a range that is based on a value of the contact radius associated with the contact.

### BACKGROUND

There are a wide variety of social networking sites available over the Internet. These sites allow subscribers to define some level of privacy settings to control what information the subscriber is sharing with other subscribers. However, the available settings define a rather course division of subscribers into groups, such as one group for those that the subscribers have mutually identified as friends, another group for friends of friends at one or more levels of separation, another group for non-friend subscribers on one or more a regional networks, and a last group of non-friend subscribers in the entire social network. The subscriber's personal information is also divided into categories. The privacy settings allow an individual subscriber (a user) to assign to groups of the other subscribers access for the categories of information. While default assignments are often provided, it is tedious and difficult for the user to change all the defaults and manage the changed setting thereafter. Furthermore, it is not possible for the user to differentiate the information among other subscribers who fall within one of the groups of subscribers. For example, the user might not want to share the same information with all subscribers who are in the friends group, but rather might want to share some information with close friends; while withholding that information from friends who are less close and acquaintances who both happen to be in the friends group.

### Some Example Embodiments

Therefore, there is a need for a less tedious, more intuitive way to manage the private information shared among other subscribers than is currently available in social networks.

According to one embodiment, a computer-readable storage medium carries instructions which, when executed by a processor, cause the one or more processors to at least perform receiving data that indicates a contact radius and an information radius. The contact radius is related to how socially close a contact is to a user who is registered with a network service. The information radius is related to how private is information about the user. In response to a request from the contact for information about the user, information about the user is provided, which has an information radius value in a range that is based on a value of the contact radius associated with the contact.

According to another embodiment, an apparatus comprises a processor and a memory storing executable instructions that if executed cause the apparatus to receive data that indicates a contact radius and an information radius. The contact radius is related to how socially close a contact is to a user who is registered with a network service. The information radius is related to how private the information about the user is. In response to a request from the contact for information about the user, the processor and memory are also configured to provide information about the user, which has an information radius value in a range that is based on a value of the contact radius associated with the contact.

According to another embodiment, an apparatus comprises a means for receiving data that indicates a contact radius and an information radius. The contact radius is related to how socially close a contact is to a user who is registered with a network service. The information radius is related to how private the information about the user is. The apparatus includes a means for providing information about the user, in response to a request from the contact for information about the user. The provided information has an information radius value in a range that is based on a value of the contact radius associated with the contact.

According to another embodiment, a method includes receiving data that indicates a contact radius and an information radius. The contact radius is related to how socially close a contact is to a user who is registered with a network service. The information radius is related to how private the information about the user is. In response to a request from the contact for information about the user, information about the user is provided, which has an information radius value in a range that is based on a value of the contact radius associated with the contact.

According to another embodiment, a method includes providing access to receive a request from a contact for information about a user who is registered with a network service. The method includes transferring information about the user, in response to receiving the request. The transferred information has an information radius value in a range that is based on a value of a contact radius associated with the contact. The contact radius is related to how socially close the contact is to the user. The information radius is related to how private the information about the user is.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings, in which:

FIG. 1 is a diagram of a system for managing information privacy settings, according to one embodiment;

FIG. 2 is a diagram of a user metadata entry, according to one embodiment;

FIG. 3 is a diagram of components of a network privacy service module, according to one embodiment;

FIG. 4 is a diagram of a graphical user interface for managing information privacy, according to one embodiment;

FIG. 5 is a flow diagram of a method at a server for managing information privacy, according to one embodiment;

FIG. 6 is a flow diagram of a method at a user node for managing information privacy, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a terminal that can be used to implement an embodiment of the invention.

### DETAILED DESCRIPTION OF EXAMPLE EMBODIMENTS

A method, apparatus, and software are disclosed for intuitive management of privacy settings. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although several embodiments of the invention are discussed with respect to information gathered at a mobile terminal with a wide arrangement of data gathering mechanisms for a user of a single social network, embodiments of the invention are not limited to this context. It is explicitly anticipated that in some embodiments the user is operating at a fixed terminal with many fewer data gathering mechanisms or at different times on one or more of multiple devices of mixed data gathering capability and mobility, as a subscriber to one or more network services that might or might not be classified as social network services.

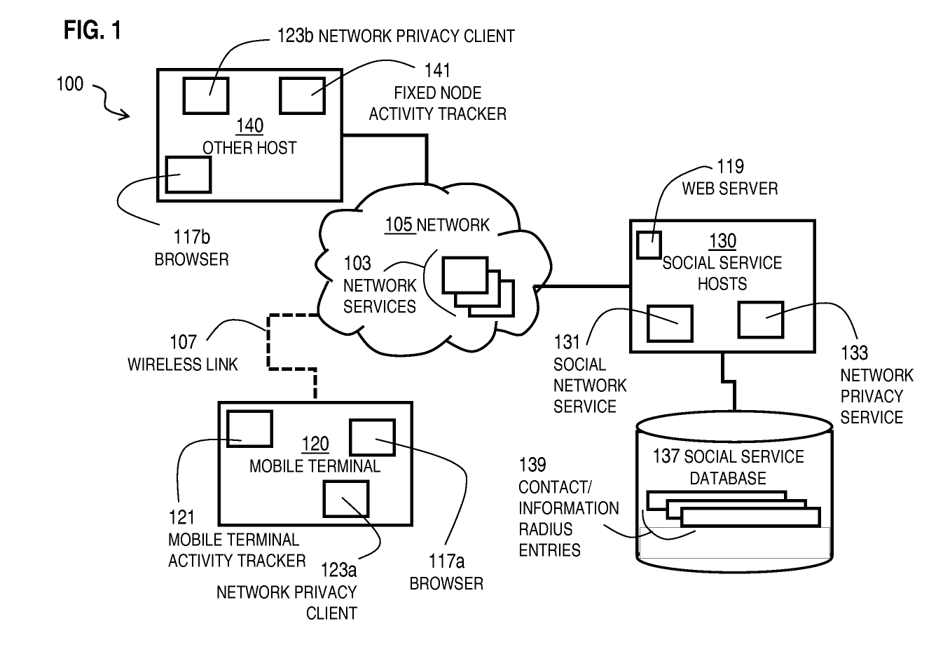

FIG. 1 is a diagram of a system 100 for managing information privacy settings, according to one embodiment. The system includes network 105 and network nodes identified as mobile terminal 120, social service hosts 130 and other host 140.

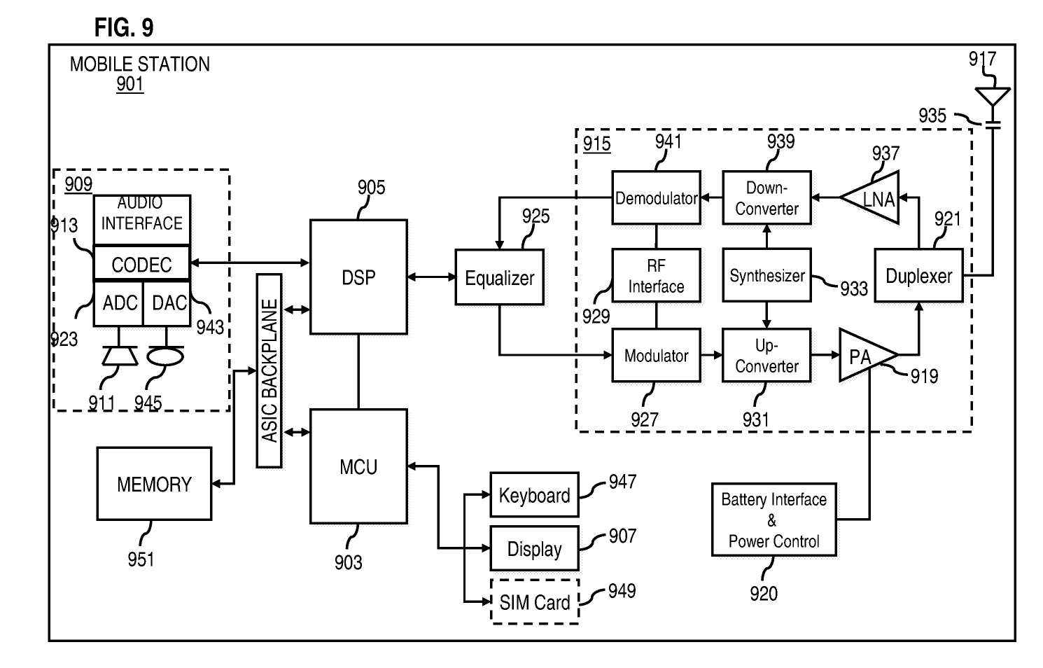

In various embodiments, nodes 120, 130, 140 can be any type of fixed terminal, mobile terminal, or portable terminal including desktop computers, laptop computers, handsets, stations, units, devices, multimedia tablets, Internet nodes, communicators, Personal Digital Assistants (PDAs), mobile phones, mobile communication devices, audio/video players, digital cameras/camcorders, televisions, digital video recorders, game devices, positioning devices, or any combination thereof. Moreover, the nodes may have a hard-wired energy source (e.g., a plug-in power adapter), a limited energy source (e.g., a battery), or both. It is further contemplated that the nodes 120, 130, 140 can support any type of interface to the user (such as “wearable” circuitry, etc.). In the illustrated embodiment, node 120 is a wireless mobile terminal (also called a mobile station and described in more detail below with reference to FIG. 9). The mobile terminal 120 is connected to network 105 by a wireless link 107.

By way of example, the communication network 105 of system 100 can include one or more wired and/or wireless networks such as a data network (not shown), a wireless network (not shown), a telephony network (not shown), or any combination thereof, each comprised of zero or more nodes. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network, or any combination thereof. In addition, the wireless network may be, for example, a cellular network and may employ various technologies including code division multiple access (CDMA), wideband code division multiple access (WCDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, wireless fidelity (WiFi), satellite, and the like. In various embodiments, communication network 105, or portions thereof, can support communication using any protocol, for example, the Internet Protocol (IP).

Information is exchanged between network nodes of system 100 according to one or more of many protocols (including, e.g., known and standardized protocols). In this context, a protocol includes a set of rules defining how the nodes interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model. The OSI Reference Model is generally described in more detail in Section 1.1 of the reference book entitled “Interconnections Second Edition,” by Radia Perlman, published September 1999.

The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. A well known client process available on most nodes connected to a communications network is a World Wide Web client (called a “web browser,” or simply “browser”) that interacts through messages formatted according to the hypertext transfer protocol (HTTP) with any of a large number of servers called World Wide Web servers that provide web pages. In the illustrated embodiment, mobile terminal 120 and other host 140 include browser 117a and browser 117b, respectively; and hosts 130 include web server 119.

Social service hosts 130 include a social network service module 131 and a network privacy service module 133, as well as the web server module 119 described above. The different modules depicted on social service hosts 130 may reside at one or more different locations in network 105. The social network service module 131 provides social networking services that allow multiple subscribers (i.e., registered users) to share certain types of information. Several social networks are known in the art such as FACEBOOK™ for sharing digital photos and digital text including favorite links to Web pages. NOKIA™ OVI™ is a social network for sharing music, location data and other media that might be gathered or rendered, or both, on a mobile device, such as a cell phone.

Network privacy service module 133 provides an intuitive way to provide privacy setting for user information at any granularity indicated directly or indirectly by the user. The network privacy service module obtains, for each user, data about the relative privacy of different information about the user and the relative closeness of different persons, called contacts, who come into communication or physical contact with the user. Neither the user nor the contact need be a subscriber to the network privacy service, but might be a subscriber to one or more different network services, such as an email service or a news stream service; and that different service utilizes the network privacy service. Thus as used here, a contact is an entity, such as person or organization or network service with whom the user has communicated, whether that entity is a registered user of a particular social network service or not. In FIG. 1, other network services 103 are depicted in network 105.

According to the illustrated embodiments, both the relative degree of privacy for particular user information and the relative closeness to the user of a contact are represented by numerical values (each called a radius). The relative degree of privacy is called the information radius. The relative closeness of a contact is called the contact radius. In the illustrated embodiments, the information radius and the contact radius are on the same scale. However, in other embodiments, the numerical values used for information radius is on a different scale than the numerical values used for contact radius; and, a scale factor or transform algorithm is used to convert values in one scale to corresponding values in the other scale.

A contact is provided with user information which has an information radius value in a range that is based on a value of a contact radius associated with the contact. For example, in some embodiments, a contact has access to all user information with an information radius greater than or equal to the contact's contact radius, but not to any information with an information radius less than the contact's contact radius.

The modules on social service hosts 130 store and retrieve data from one or more social service data structures, such as social service database 137. In the illustrated embodiment, the social service database includes, for one or more users, entries 139 for contact radius and information radius data (called contact/information radius entries 139).

The mobile terminal 120 includes the Web browser 117a, described above, a mobile terminal activity tracker module 121, and a network privacy client module 123a. Similarly, the other host 140 includes the Web browser 117b, described above, a fixed node activity tracker module 121, and a network privacy client module 123b. The network privacy client modules 123a, 123b, collectively referenced hereinafter as network privacy client module 123, interface with a user of the local node and communicate with the network privacy service module 133 to provide the information eventually stored in the contact/information radius entries 139. In some embodiments, the functions of the network privacy client 123 are accomplished by a combination of standard graphical user interface elements of a web browser 117 in concert with web pages generated for this purpose by web server 119 responding to the network privacy service module 133. In such embodiments, a separate network privacy client module 123 is omitted.

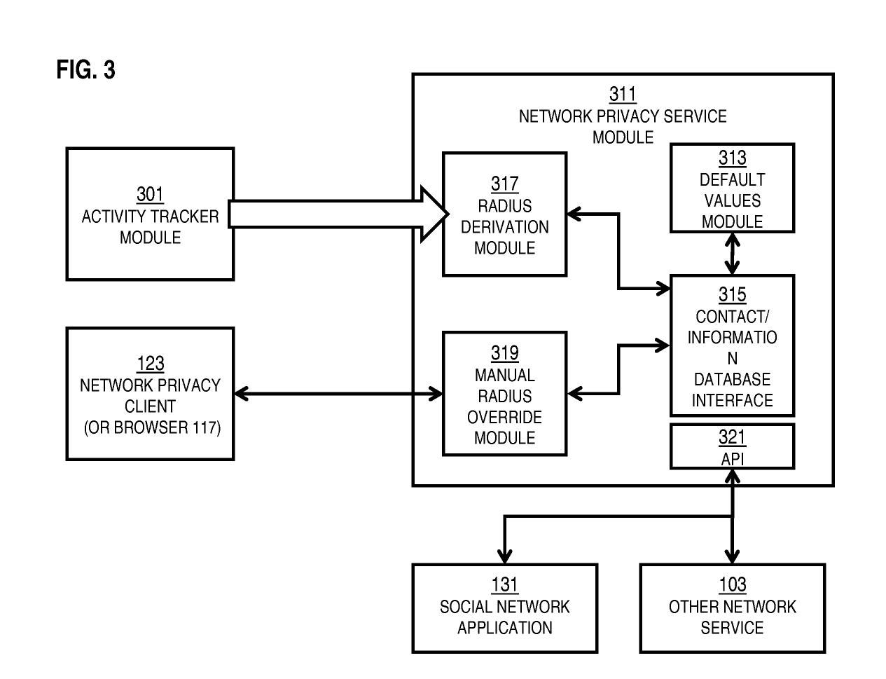

In some embodiments, information radii and contact radii for a user of mobile terminal 120 are derived based, at least in part, on user activity on the mobile terminal 120. As used herein, activity on the mobile terminal includes one or more network communications with each of one or more contacts, or proximity of mobile terminal 120 to the address or mobile location of each of one or more contacts, or some combination. In such embodiments, the mobile terminal 120 includes a mobile terminal activity tracker module 121 that detects those communications and proximity events and reports those activities, or statistical data or radii derived from them, to the network privacy service module 133 over network 105. Similarly, if the other host 140 is a fixed terminal in such embodiments, then the other host 140 includes a fixed terminal activity tracker module 141 that detects those communications and reports those activities, or statistical data or radii derived from them, to the network privacy service module 133. The derivation of activity statistics or a radius from activity data is described in more detail below with reference to FIG. 3

Although a particular set of nodes, processes, and data structures are shown in FIG. 1 for purposes of illustration, in various other embodiments more or fewer nodes, processes and data structures are involved. Furthermore, although processes and data structures are depicted as particular blocks in a particular arrangement for purposes of illustration, in other embodiments each process or data structure, or portions thereof, may be separated or combined or arranged in some other fashion. For example, in some embodiments, the web server 119 is included in the network privacy service module 133. In some embodiments, the network privacy service module 133 is included in the social network service module 131. Likewise, in some embodiments, the mobile terminal activity tracker is included in the network privacy client module 123a. In some embodiments, the network privacy client module 123 is a plug in application for the browser 117. In some embodiments, user input is provided via browser 117 and privacy client 123a is omitted.

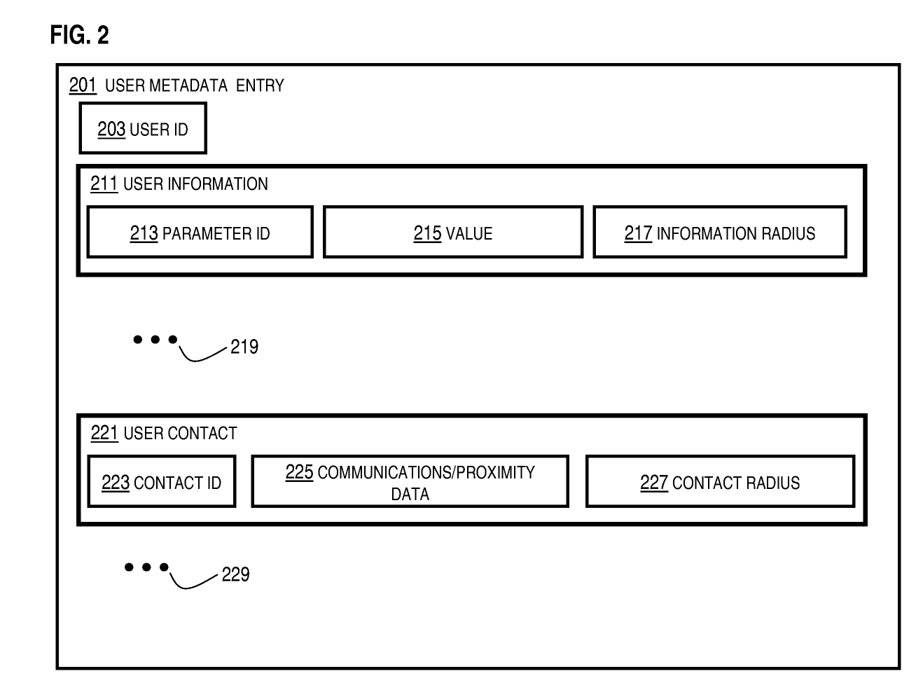

FIG. 2 is a diagram of a user metadata entry 201, according to one embodiment. In this embodiment, the user metadata entry 201 includes contact/information radius entries 139 among the included fields. The included fields are user identification (ID) field 203, user information field 211 and other user information fields indicated by ellipsis 219, and user contact field 221 and other user contact fields indicated by ellipsis 229.

User ID field 203 holds data that indicates a particular user among all the network users whose privacy settings are managed by the network privacy service 133. In some embodiments, user ID field 203 holds multiple user IDs, if known, for the same user as that user presents himself or herself to multiple network services 103 and social network service 131.

User information field 211 holds data that indicates information about the user that might be shared with one or more other users of network services 103 and social network service module 131 or with the user's contacts who are not registered users. The user information field includes a parameter identifier (ID) field that indicates a particular parameter of all those used to describe the user and a value field 215 that holds data that indicates a value for the particular parameter. According to the illustrated embodiment, the user information field includes an information radius field 217 that holds data that indicates the relative privacy indicated by the user's actions for the parameter indicated in field 213. Fields for other parameters used to describe the user are indicated by ellipsis 219. Example parameters used to describe a user, and stored in one or more user information fields 211 and 219, are one or more of actual and logon name(s), gender, birthdate, physical address(es), email address(es), political persuasion, religious persuasion, Websites, favorite foods, favorite merchants, favorite books, movies, music and other media, club memberships, and network service(s) to which user subscribes, among other parameters. In some embodiments, the parameter described by a value indicated in value field 215 is implied by the position of the user information field 211 in the user metadata entry 201, and the parameter field 213 is omitted.

User contact field 221 holds data that indicates a contact of the user, with whom the user has been in communication or physical proximity or both. The user contact field 221 includes a contact identifier (ID) field 223, a communications/proximity data field 225, and a contact radius field 227. The contact ID field 223 holds data that indicates a particular contact of the user, such as an User ID for that contact, if the contact is also a subscriber to the network service module 133 or one of the network services 103 or 131, or an email address or a website address.

The communications/proximity data field 225 holds data that indicates the medium and amount of time the user has been in contact with the entity identified in field 223, either by communication or by physical proximity. Communication contacts can be determined in any manner known in the art. For example in some embodiments, communication contact is determined by a cell phone capable mobile terminal based on cell phone call number and duration in call logs, and based on text messages (e.g., sent via the short message service, SMS, protocol). Communication contact is determined by most network nodes, whether or not they are mobile terminals, based on number of and language contained in emails, instant messages, visits and text provided to the contact's social page or visits and text on the user's web page by the contact, among others, alone or in some combination. Proximity contacts can be determined in any manner known in the art. For example in some embodiments, proximity contact is determined by a global positioning system (GPS) capable mobile terminal log of position by time, or detection of the contact's wireless short range broadcasts (e.g., Bluetooth signals), or by most fixed network nodes based on an address associated with the user of the fixed terminal, among others, alone or in some combination.

According to the illustrated embodiment, the user contact field 221 includes a contact radius field 227 that holds data that indicates the relative closeness of the contact to the user as indicated by the user's actions, and possibly also by the contact's actions, as described in more detail below. Fields for other contacts of the user are indicated by ellipsis 229.

Although the depicted fields in FIG. 2 are shown as integral blocks of data in a particular order in a single data structure for purposes of illustration, in other embodiments one or more fields, or portions thereof, are arranged in a different order in one or more data structures in one or more databases residing on one or more nodes connected directly or indirectly to network 105. In some other embodiments, one or more depicted fields or portions thereof are omitted, or additional fields are included.

FIG. 3 is a diagram of components of a network privacy service module 311, according to one embodiment. Network privacy service module 311 is a particular embodiment of network privacy service module 133 depicted in FIG. 1. The network privacy service module 311 interacts with the network privacy client module 123, the social network application 131, and other network services 103 depicted in FIG. 1. The network privacy service module 311 also interacts with an activity tracker module 302, such as mobile terminal activity tracker module 121 or fixed node activity tracker module 141 depicted in FIG. 1. In the illustrated embodiment, the network privacy service module 311 includes a default values module 313, a contact/information database interface 315, a radius derivation module 317, manual radius override module 319, and an application programming interface (API) 321. Specifications for the API 321 are promulgated to developers of the social network application 131 and other network service 103, so that those services can request information about a user for a given contact. The API 321 receives any requests from these services and replies with the parameters or values that the specified contact has access to. For example, the module 311 provides through the API data that indicates the user, the contact and the contact radius, in response to a request from a different network service 131 or 103. Similarly, the API 321 is used by the network privacy service module 311 to request and obtain information from the social network application 131 of other network service 103, such as the group in which a particular contact of a particular user belongs.

The default values module 313 produces default contact radius values for a user's contacts and default information radius values for categories of user information. For purposes of illustration, it is assumed that the default information categories and contact groups and associated radii are as indicated in Table. 1. It is further assumed that the information radius and the contact radius use the same scale. It is further assumed that a contact has access to all information about a user with an information radius greater than or equal to the contact's contact radius, but not to any information with an information radius less than the contact's contact radius.

TABLE 1
Example, default radius values for information and contact groups

| Information category | Information radius |
|---|---|
| Physical location | 1 |
| Phone number | 2 |
| Email address | 3 |
| Service name | 4 |
| Contacts group | Contact radius |
| Friends | 2.5 |
| Friends of friends | 3.5 |
| Regional network | 3.5 |
| Other contacts | 3.5 |
| Others | 5 |

According to the default values in Table 1, no contact is given access to the user's physical location (e.g., home address or current GPS position) or given access to the user's phone number. The default values allow contacts in a friends group to access the user's email and service name (e.g., Mike the Marvelous). The default values allow contacts in the friends of friends group, the regional network group, and the other contacts group to access only the user's service name. An entity which does not fall into any of these previous groups, e.g., a person or organization or network service with whom the user has never communicated, falls into the others group and is given access to none of the user's information, not even to the service name.

The contact/information database interface module 315 is used to store and retrieve data from one or more databases with the contact radius and information radius data for one or more users, such as database 137. Any database interface may be used. For example, the default values of Table 1 are used to initially fill or update the radius fields 217 and 227 of the user metadata entry 201 for a particular user, UserA. An association of a contact ID with a contact group, and therefore the appropriate contact radius, is determined based on information stored in a field (not shown) in the user contact field 221 or obtained from a social network application 131, e.g., through API 321. For purposes of illustration, it is assumed that user A has 6 contacts, 5 of whom are in the friends group, and one of whom is in the other contacts group. After the default settings, the user metadata entry 201 for UserA is shown in Table 2.

TABLE 2
Example metadata entry for user A after default module
UserA

| Parameter ID | Value | Info radius |
|---|---|---|
| Physical location | 15.0000N, 15.0000E | 1 |
| Phone number | 999-555-1234 | 2 |
| Email address | UserA@serviceprovider.com | 3 |
| Service name | Mike the Marvelous | 4 |

| | Communications/ | |
|---|---|---|
| Contact ID/name (group) | proximity data | Contact radius |
| 413/Partner (Friend) | none | 2.5 |
| 415/Close.Friend (Friend) | none | 2.5 |
| 417/School.Mate (Friend) | none | 2.5 |
| 421/Colleague.A (Friend) | none | 2.5 |
| 423/Colleague.B (Other Contact) | none | 3.5 |
| 425/Colleague.C (Friend) | none | 2.5 |

The radius derivation module 317 receives activity date from the activity tracker module 301 and derives any modifications to the radius values already stored in the database, e.g., database 137. In some embodiments, the activity data received or statistical summaries of that data are stored by the radius derivation module 317 in the database, e.g., in the communications/proximity data field 225 of the user metadata entry 201, based on the user and contact or information involved in the activity. Any method may be used to derive a radius that reflects the relative closeness of a contact or the relative privacy of the information parameter from the user's activity involving the user's contact.

In various embodiments, the radius derivation module determines a radius based on the frequency and duration of communications with a contact, the type of information included in the communications with the contact, the similarity between the metadata of the user and the metadata of the contact, the similarity of the metadata of the contact with the metadata of another contact for whom the user has provided a manual value of the contact radius, and the frequency and duration of physical proximity, among other factors, alone or in any combination. The modified radius value, if any, is then stored in the database in place of the default value. For purposes of illustration it is assumed that the communications/proximity data and revised contact radius stored in the user metadata entry for UserA as a result of operation of the radius derivation module 317 are as shown in Table 3. For purposes of illustration it is assumed that the communications/proximity data field includes four portions separated by slashes in Table 3, which report on: (1) the number of communications; (2) the median proximity; (3) the average duration of a communication; and (4) the frequency of communications, respectively. In other embodiments other data are included in the communications/proximity data field 225, such as type of information in the communications or occurrence of the specific private user information in a communication with the contact. Thus the one Friends group is further divided to produce a finer granularity of relationships than provided by the default settings or prior approaches.

TABLE 3
Example metadata entry for user A after radius derivation module
UserA

| Parameter ID | Value | Info radius |
|---|---|---|
| Physical location | 15.0000N, 15.0000E | 1 |
| Phone number | 999-555-1234 | 2 |
| Email address | UserA@serviceprovider.com | 3 |
| Service name | Mike the Marvelous | 4 |

| | | Contact |
|---|---|---|
| Contact ID/name (group) | Communications/proximity data | radius |
| 413/Partner (Friend) | Many/close/long while/every day | 0.1 |
| 415/Close.Friend (Friend) | Many/close/medium while/often | 0.5 |
| 417/School.Mate (Friend) | Few/far/long while/rare | 2.5 |
| 421/Colleague.A (Friend) | Few/close/short while/rare | 2.5 |
| 423/Colleague.B | Few/not close/short while/rare | 3.5 |
| (Other Contact) | | |
| 425/Colleague.C (Friend) | Many/close/short/average | 1.5 |

The manual radius override module 319 sends the current privacy setting for presentation to the user, e.g., by generating a web page in response to a web page request form a browser 117, or by sending a message in response to a request from a special purpose network privacy client module 123. The manual radius override module 319 receives data indicating any user changes to the information radius or contact radius and stores the result in the database through the contact/information database interface 315. In some embodiments, the presentation of the information and contact radius to the user is a graphical user interface that maps icons representing the contacts into circles representing the different degrees of privacy of the user information.

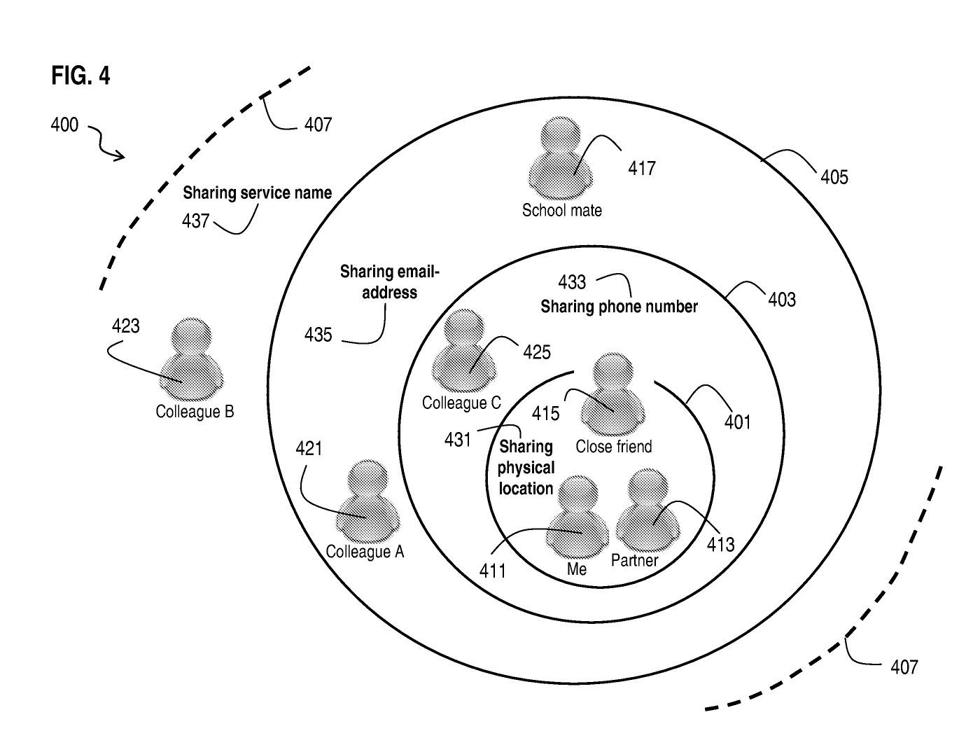

FIG. 4 is a diagram of a graphical user interface 400 for intuitively managing information privacy, according to one embodiment. The graphical user interface 400 includes nested circles to represent the different information radii for the user. Circles are nested when the circle with the smaller radius lies entirely within a circle with a larger radius. In some embodiments, the nested circles are concentric. For example, in FIG. 4, the four radii 1, 2, 3 and 4 for the four pieces of user information in the example: (physical location, phone number, email address and service name, respectively), are shown by the four nested circles, circle 401, circle 403, circle 405 and circle 407, respectively. In some embodiments, the information associated with each circle is indicated by a label giving the name of the parameter shared in that circle, e.g., label 431, label 433, label 435 and label 437 for circle 401, circle 403, circle 405, and circle 407, respectively.

The graphical user interface 400 also includes an icon (such as a default graphical figure, a photo image or avatar) to represent each contact of the user. In the illustrated embodiment, the icon includes a name for the contact. Each icon is positioned inside the innermost nested circle with a radius greater than or equal to the contact radius of that contact. Each contact is granted access to the information associated with all the circles the icon associated with the contact is inside. The user is implicitly in the innermost circle and in some embodiments the user is also represented by an icon, e.g., icon 411 representing UserA, labeled “Me” in FIG. 4. For example, each of UserA's contacts' icons, labeled by the contact ID number, is placed in the proper circle. The icons can be moved around to avoid obscuring each other as long as they are based in the correct annular or circular area. Thus, the user can readily and intuitively determine what information is granted to which contacts. In embodiments with concentric circles, each icon is simply plotted at a distance equal to that icon's corresponding contact radius from the shared center of the circles. To avoid obscuring icons with equal or similar radii, each icon can be plotted at its radius from the center but at a different angle.

For example, contact icon 413 (Partner) and contact icon 415 (Close Friend) with contact radii 0.1 and 0.5, respectively (both less than 1.0), are in the innermost circle with information radius 1, representing access to the UserA's physical location. These contacts also have access to the information represented by the outer circles 403, 405 and 407. Similarly, contact 425 (Colleague C), with contact radius 1.5, lies outside the innermost circle 401 with information radius 1 and inside the second circle 403, with radius 2, which represents access to UserA's phone number. This contact is denied access to UserA's physical location in the circle with a smaller radius, but is granted access to UserA's phone number and information represented by the outer circles 405 and 407. Contact 417 (School Mate) and contact 421 (Colleague A) with contact radii of 2.5, lie outside the second circle 403 with information radius 2 and inside the third circle 405, with radius 3, which represents access to UserA's email address. These contacts are denied access to UserA's physical location and phone number in the circles with smaller radii, but are granted access to UserA's email address and information represented by the outer circle 407. Contact 423 (Colleague B), with contact radius 3.5, lies outside the third circle 405 with information radius 3 and inside the fourth circle 407, with radius 4, which represents access to UserA's service name. This contact is denied access to UserA's physical location, phone number and email address in the circles with smaller radii, but is granted access to UserA's service name.

In some embodiments, the user can intuitively provide manual input to change the privacy settings by changing a circle's radius, or moving an icon to a different position among the circles, or both. For example, the user can operate a pointing device to place a cursor on a circle to select the circle and then drag the curser to change the radius of that circle to encompass more or fewer icons or to change the relative privacy. For example, to make the phone number less private than the email address, the user can drag circle 405 to give it a smaller radius, and then drag circle 403 to give it a bigger radius, until it is outside circle 405. Alternatively, the user can activate a button graphical element (not shown) to add a new circle and select a new parameter ID (e.g., from a pull down menu, not shown) to associate with the new circle.

Similarly, the user can change the innermost circle associated with a contact by using a pointing device to place a cursor on the icon to select the icon, and then drag the curser to change the position of the icon. The icon is given a new radius to comport with the values of the two circles the moved icon now lies between, and any other icon that lies closer or father from the center of the destination circle. Alternatively, the user can activate a button graphical element (not shown) to add a new icon and select a new contact ID (e.g., from a pull down menu, not shown) to associate with the new icon.

Although FIG. 4 depicts all icons as identical for purposes of illustration, in other embodiments the icons of different contacts may be different. For example, the icon is an image of the individual in some embodiments; or a different icon is used for each group of individuals in other embodiments. It is the position of the icon, not the shape of the icon, that indicates the access to private information in the illustrated embodiments.

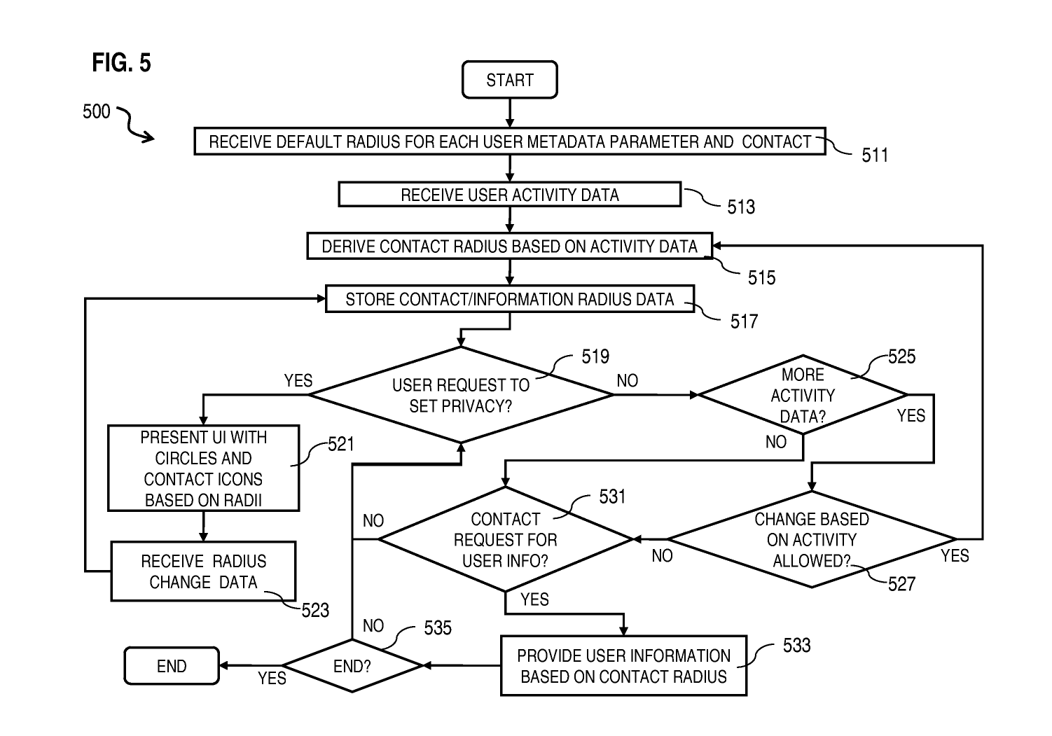

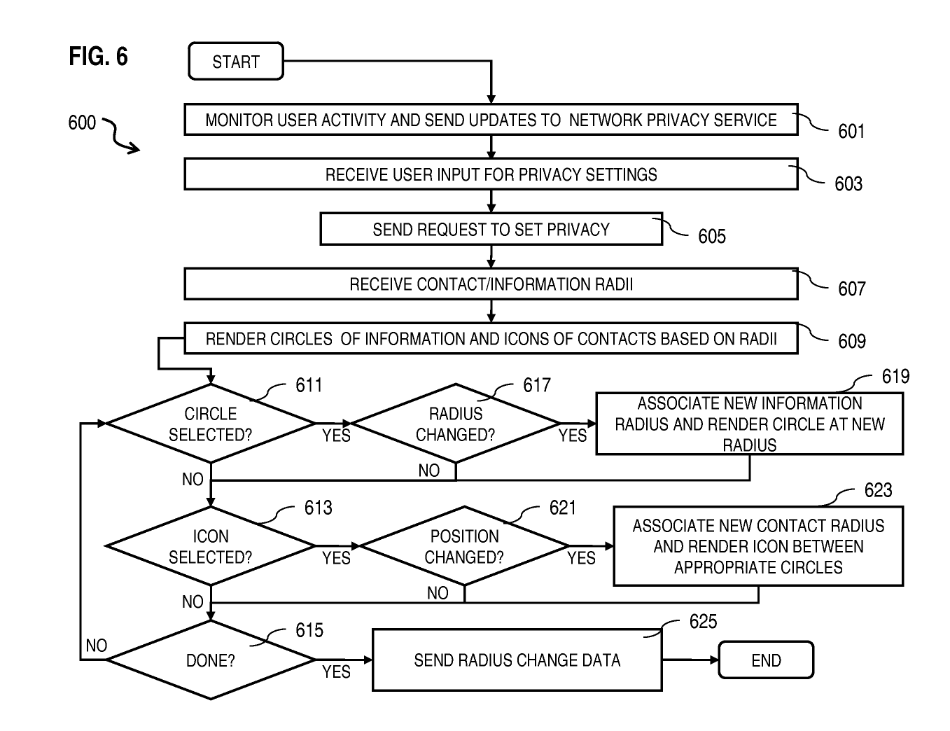

FIG. 5 is a flow diagram of a method 500 at a server for managing information privacy, according to one embodiment. Although steps in FIG. 5 and subsequent flow chart FIG. 6 are shown in a particular order for purposes of illustration, in other embodiments, one or more steps may be performed in a different order or overlapping in time, in series or in parallel, or one or more steps may be omitted or added, or changed in some combination of ways.

In step 501, a default information radius is received for each user metadata parameter and a default contact radius is received for each contact of the user. Any method may be used to receive this data. For example, in various embodiments, the data is included as a default value in software instructions, is received as manual input from a network service administrator on the local or a remote node, is retrieved from a local file or database, or is sent from a different node on the network, either in response to a query or unsolicited, or the data is received using some combination of these methods. In an illustrated embodiment, step 501 is accomplished by the default values module 313.

In step 513, user activity data is received, e.g., from activity tracker module 301, as described above with reference to the activity tracker module 301. In step 515, a contact radius or information radius is derived from the activity data as described above with reference to the radius derivation module 317. In some embodiments without a radius derivation module 317, step 513 and step 515 are omitted.

In step 517, the contact radius values and information radius values for one or more users are stored, e.g., as a user metadata entries such as entry 201 in database 137, described above.

In step 519, it is determined whether a user request is received to set privacy. If so, then in step 521 the user is presented with a user interface (UI) to make the changes to a contact radius or information radius. For example, a message is sent to a network privacy client 123 or a web page is sent to the browser 117 on the user's device (e.g., mobile terminal 120) to present the graphical user interface 400. In step 523, the radius change data is received, e.g., in an HTTP message from the browser 117 or a message from the network privacy client 123. The changed radius information is stored in step 517.

If, as determined in step 519, a request to set privacy is not received, then it is determined in step 525 whether activity data is received. If so, then it is determined in step 527 whether change of radius is allowed based on activity. In some embodiments, manually input radius values may not be change based on activity data, so the receipt of activity data for a user who already provided manual radius input in step 523 is not allowed in step 527. In some embodiments, the user's manual import is considered along with the activity data; and, therefore in such embodiments, adjustments to the radius values are allowed. If a change in radius based on activity data is allowed, then the change or changes are derived in step 515 based on the new activity data received in step 525.

If activity data is not received, or radius changes based on received activity data are not allowed, then in step 531 it is determined whether a contact is requesting user information. The request may be directly from the contact or indirectly from a network service the contact subscribes to, e.g., a social network service 131. In some embodiments, the contact is the network service.

If no such request is received, then it is determined in step 535 whether to end the process. If so, then the process ends. If not, then the next message is examined to determine whether it is a request to set privacy in step 519 or more activity data in step 525 or a request from a contact for user information in step 531.

FIG. 6 is a flow diagram of a method 600 at a user node for managing information privacy, according to one embodiment. The steps of method 600 may be performed by one or more modules on a user node, such as on mobile terminal 120 or other host 140.

In step 601, user activity on the node is monitored to cull data about the communication and proximity of the user with various contacts, as described above for the activity tracker module 301.

In step 603, user input is received indicating a desire for privacy settings, either to review current setting or to change one or more settings. For example, a curser activate operation is detected when a cursor lies over a graphical element representing a privacy setting tab. In step 605, a request to set privacy is sent, e.g., to the network privacy service module 133 or 311. In step 607 contact radii and information radii data is received, e.g., in a web page at a browser 117 or in a message to a network privacy client module 123.

In step 609 a graphical user interface, such as GUI 400, is presented to the user by rendering circles at the information radii for the user and rendering icons representing contacts at positions within the innermost circle with a radius greater than the contact radius, as shown in FIG. 4.

In step 611, it is determined whether a circle is selected, e.g., by detecting an activated pointing device while a cursor is positioned near a circle edge or an “add circle” button. If not, then it is determined in step 613 whether an icon is selected, e.g., by detecting an activated pointing device while a cursor is positioned near an icon or an “add contact” button. If not, then it is determined in step 615 whether the process is done, e.g., by detecting an activated pointing device while a cursor is positioned over a “Submit” button. If not, then the checks of step 611, step 613 or step 615 are repeated.

If it is determined that a circle is selected in step 611, then it is determined in step 617 whether a circle radius is changed, e.g., by detecting an existing circle being dragged or a new circle being added. If not, then the checks of step 611, step 613 or step 615 are repeated. If so, then in step 619, the new radius is associated with the information of the existing or new circle and the circle is rendered at the new radius.

If it is determined that an icon is selected in step 613, then it is determined in step 621 whether the icon position is changed, e.g., by detecting an existing icon being dragged or a new icon being added. If not, then the checks of step 611, step 613 or step 615 are repeated. If so, then in step 623, a new contact radius based on the position is associated with the contact of the existing or new icon; and, the icon is rendered inside the correct one or more circles based on the new radius.

If it is determined that the process ends in step 615, e.g., because the new radius data is to be submitted, then in step 625 the radius change data is sent, e.g., to the network privacy service module 133 or 311. Then the process ends.

The processes described herein for intuitive privacy settings may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such example hardware for performing the described functions is detailed below.

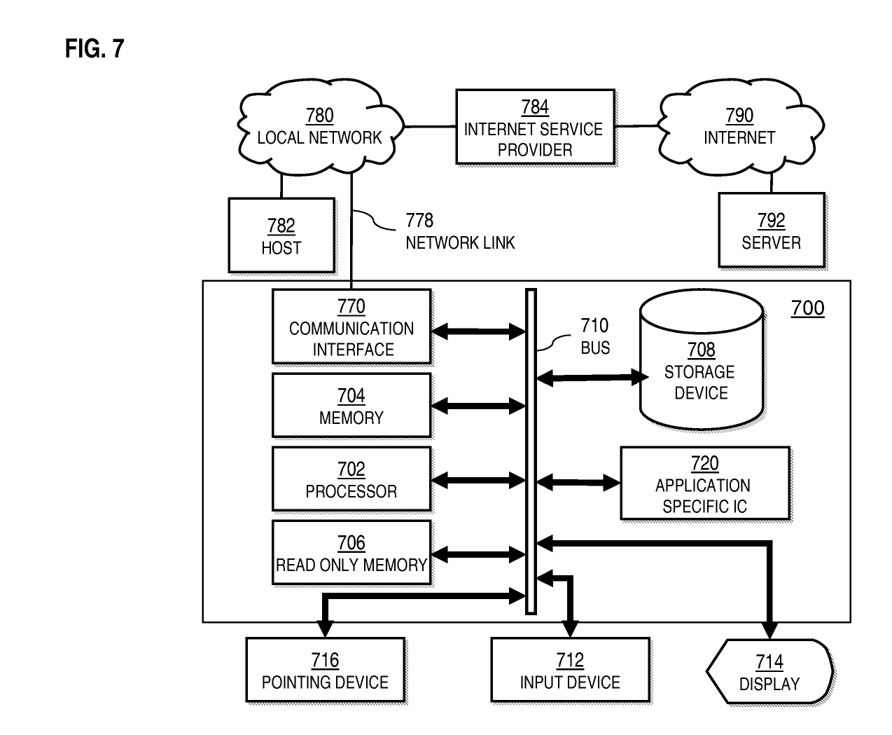

FIG. 7 illustrates a computer system 700 upon which an embodiment of the invention may be implemented. Computer system 700 includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information. The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a transmission medium such as a cable or carrier wave, or any other medium from which a computer can read. Information read by a computer from computer-readable media are variations in physical expression of a measurable phenomenon on the computer readable medium. Computer-readable storage medium is a subset of computer-readable medium which excludes transmission media that carry transient man-made signals.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790. A computer called a server host 792 connected to the Internet hosts a process that provides a service in response to information received over the Internet. For example, server host 792 hosts a process that provides information representing video data for presentation at display 714.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

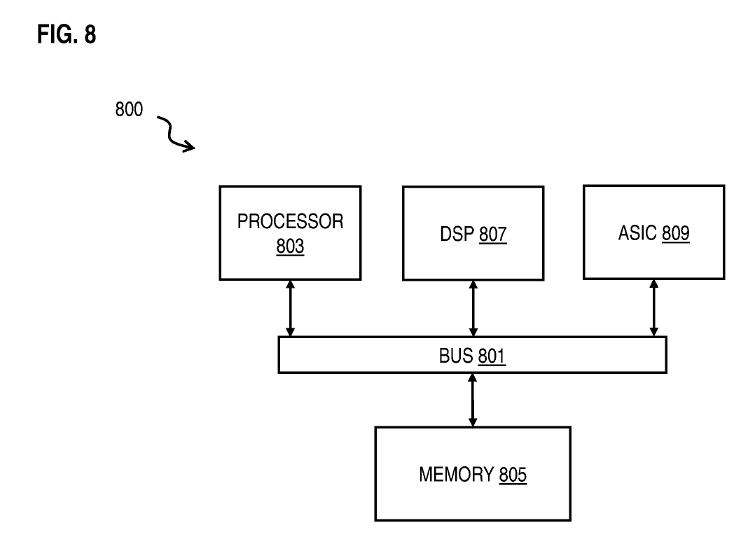

FIG. 8 illustrates a chip set 800 upon which an embodiment of the invention may be implemented. Chip set 800 is programmed to carry out the inventive functions described herein and includes, for instance, the processor and memory components described with respect to FIG. 8 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-word signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein. The memory 805 also stores the data associated with or generated by the execution of the inventive steps.

FIG. 9 is a diagram of example components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the station include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In the example embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The MCU 903 delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving data that indicates
a contact radius related to how socially close a contact is to a user who is registered with a network service, and
an information radius related to how private is information about the user; and
in response to a request from the contact for information about the user, providing information about the user which has an information radius value in a range that is based on a value of the contact radius associated with the contact.

2. A method of claim 1, wherein a smaller radius indicates a socially closer contact or more private information, the method further comprising
providing information about the user comprises providing information about the user which has an information radius no less than a contact radius of the contact.

3. A method of claim 1, further comprising initiating presentation of a graphical user interface that shows:
a plurality of nested circles representing corresponding information radii for a plurality of associated private information about the user; and
a plurality of icons for associated contacts positioned among the plurality of nested circles based on a corresponding plurality of associated contact radii,
wherein each icon of the plurality of icons is inside a circle with a information radius greater than a contact radius associated with the icon and outside a circle with an information radius less than the contact radius.

4. A method of claim 3, wherein receiving information that indicates a contact radius further comprises receiving user input data that indicates a change in a position of an icon associated with the contact.

5. A method of claim 3, wherein receiving data that indicates an information radius further comprises receiving user input data that indicates a change in a radius of a circle for the information about the user.

6. A method of claim 1, wherein receiving data that indicates a contact radius further comprises:
automatically receiving further data that indicates communications between the user and the contact; and
automatically deriving the contact radius based on the further data.

7. A method of claim 1, wherein receiving data that indicates a contact radius further comprises:
automatically receiving further data that indicates similarity of metadata about the user with metadata about the contact; and
automatically deriving the contact radius based on the further data.

8. A method of claim 1, wherein receiving data that indicates a contact radius further comprises:
automatically receiving further data that indicates similarity of metadata about the contact with metadata about a different contact; and
automatically deriving the contact radius for the contact based on the further data and a different contact radius for the different contact.

9. A method of claim 1, wherein receiving data that indicates a contact radius further comprises:
automatically receiving further data that indicates proximity between the user and the contact and duration of proximity; and
automatically deriving the contact radius based on the further data.

10. A method of claim 3, wherein receiving data that indicates a contact radius further comprises receiving data that indicates a contact radius at a degree of granularity defined by the user.

11. A method of claim 1, further comprising:
providing data that indicates the user, the contact and the contact radius, in response to a request from a different network service.

12. An apparatus comprising at least one processor and at least one memory including computer program code, the at least one memory and the computer code configured to, with the at least one processor, cause the apparatus to perform at least the following:
receive data that indicates
a contact radius related to how socially close a contact is to a user who is registered with a network service, and
an information radius related to how private is information about the user; and
in response to a request from the contact for information about the user, provide information about the user which has an information radius value in a range that is based on a value of the contact radius associated with the contact.

13. A system including the apparatus of claim 12, the system further comprising a mobile terminal configured to send at least some of the data.

14. An apparatus of claim 12, wherein: a smaller radius indicates a socially closer contact or more private information; and, the step to provide information about the user comprises provide information about the user which has an information radius no less than a contact radius of the contact.

15. An apparatus of claim 12, wherein the apparatus is further caused to initiate presentation of a graphical user interface that shows:
a plurality of nested circles representing corresponding information radii for a plurality of associated private information about the user; and
a plurality of icons for associated contacts positioned among the plurality of nested circles based on a corresponding plurality of associated contact radii,
wherein each icon of the plurality of icons is inside a circle with a information radius greater than a contact radius associated with the icon and outside a circle with an information radius less than the contact radius.

16. An apparatus of claim 15, wherein the step to receive information that indicates a contact radius further comprises receive user input data that indicates a change in a position of an icon associated with the contact.

17. An apparatus of claim 15, wherein the step to receive data that indicates an information radius further comprises receiving user input data that indicates a change in a radius of a circle for the information about the user.

18. An apparatus of claim 12, wherein the step to receive data that indicates a contact radius further comprises:
automatically receive further data that indicates communications between the user and the contact; and
automatically derive the contact radius based on the further data.

19. An apparatus of claim 12, wherein the apparatus is further caused to provide data that indicates the user, the contact and the contact radius, in response to a request from a different network service.

20. A method comprising:
providing access to receive a request from a contact for information about a user who is registered with a network service,
in response to receiving the request, transferring information about the user which has an information radius value in a range that is based on a value of a contact radius associated with the contact,
wherein
the contact radius is related to how socially close the contact is to the user, and
the information radius is related to how private is the information about the user.
